(19) United States
(12) Patent Application Publication
(10) Pub. No.: US 2010/0109336 A1
(43) Pub. Date: May 6, 2010

(54) APPARATUS FOR WIND POWER GENERATION WITH A VERTICAL AXIS

(75) Inventor: Sang-gak Lee, Gyeonggi-do (KR)

Correspondence Address: EGBERT LAW OFFICES, 412 MAIN STREET, 7TH FLOOR, HOUSTON, TX, 77002, US

(73) Assignee: Hangug Casting Co., Ltd., Gyeonggi-do (KR)

(21) Appl. No.: 12/524,573

(22) PCT Filed: Aug. 10, 2007
(86) PCT No.: PCT/KR2007/003854

§ 371 Date: Aug. 22, 2009

(30) Foreign Application Priority Data
Jan. 30, 2007 (KR) 10-2007-0009422

(51) Int. Cl. F03D 3/02

(52) U.S. Cl. 290/55

(57) ABSTRACT

An apparatus for wind power generation with a vertical axis is provided for generating electricity without any interference from wind blowing in a direction in which electricity is not generated, such as when wind blows in different directions on every side. The apparatus includes at least one independent energy transmission vertical joint group having at least two independent energy transmissions coupled vertically to each other, fixture joint members fixing the independent energy transmission vertical joint groups in a transverse direction, a first bevel gear coupled to the joint rotary shaft of the lowermost one of the independent energy transmissions, a second bevel gear engaged with the first bevel gear, a power relay shaft passing through and fixed to the second bevel gear, a gear box coupled to one end of the power relay shaft, and a power generator coupled to the gear box and generating electricity using transmitted rotational force.

### TECHNICAL FIELD

The present invention relates, in general, to an apparatus for wind power generation with a vertical axis, and more particularly, to an apparatus for wind power generation with a vertical axis, in which, even if opposing winds blow toward a plurality of wind rotors disposed in a matrix arrangement in opposite directions, one in which electricity is generated and the other in which electricity is not generated, electricity is generated using the wind blowing in the direction in which electricity is generated without any interference from the wind blowing in the direction in which electricity is not generated, thereby preventing rotational force from being decreased by the opposing winds, which blow in a special climate environment, for instance, in different directions, particularly, in Korea.

As is generally known in the art, a wind power generator converts natural wind into electric energy by rotating a wind rotor using the wind and then driving an electric generator using gears connected with the wind rotor. Such a wind power generator is a kind of nonpolluting natural energy source, and is spotlighted as the most economical one of the alternative energy sources to replace fossil fuels.

Wind power generators are classified as horizontal axis types and vertical axis types according to the orientation of a rotary shaft having blades.

### BACKGROUND ART

FIG. 1 is a perspective view of an existing apparatus for wind power generation having a vertical axis (Korean Utility Model Registration No. 20-0019653). FIG. 2 is a sectional view illustrating the state of the wind rotor blade having the construction of FIG. 1 when in use.

As illustrated, the apparatus for wind power generation having a vertical axis comprises a plurality of rotary shafts 2 and 2′, which are rotatably installed on a base 1, a plurality of wind rotors 3, which are fixedly installed along the rotary shafts 2 and 2′ and each have four wind rotor blades 3a connected to each other in a crisscross form, support plates P and P′, which rotatably support the plurality of rotary shafts 2 and 2′, ropes 4 and 4′, which fixedly support the support plates P and P′, a rotary unit 5, which is connected to the rotary shafts 2 and 2′ and is supplied with rotational force from the rotary shafts 2 and 2′, and an electric generator 6, which converts the rotational force supplied from the rotary shafts 2 and 2′ into electricity as electric power. Among the faces constituting each wind rotor blade 3a, one that mainly comes into contact with wind, i.e. a wind pressure plate 31a, is hinged so as to be open in one direction.

For this reason, when a strong wind or a tempest is raging, the wind pressure plate 31a of each wind rotor blade 3a is open to minimize the damage to each wind rotor blade 3a.

In spite of this advantage, the apparatus for wind power generation having a vertical axis has the following drawbacks.

In general, the wind power generation functions to generate electricity in the electric generator 6 using the rotational force generated by the wind, so that the wind rotor 3 must be able to maintain rotation in one direction (here, in a counterclockwise direction) for a long time.

However, unlike the climate environment in foreign countries, the climate environment in Korea is as follows. The wind frequently changes direction, and furthermore has a different direction at the upper and lower sides of the wind rotors 3, which are vertically fixed along the rotary shafts 2 and 2′. Further, the intensity of wind corresponds to soft wind.

For this reason, in the case in which the wind, which blows toward the upper ones of the wind rotors 3, which are vertically fixed along the rotary shafts 2 and 2′, is forward wind W1, blowing in the direction in which electricity is generated, and in the case in which the wind, which blows toward the lower ones of the wind rotors 3, is reverse wind W2, blowing in a direction in which electricity is not generated, the rotary shafts 2 and 2′ are difficult to rotate from a mathematical standpoint because the wind rotors 3 are fixed to the rotary shafts 2 and 2′.

Further, because the intensity of the reverse wind W2, striking the rear surface of each wind rotor blade 3a, is weak, the wind pressure plate 31a hinged to each wind rotor blade 3a does not completely open. Hence, the space where the hinged wind pressure plate 31a is pivoted to be generated is also narrow, and thus the reverse wind W2 striking the rear surface of each wind rotor blade 3a does not smoothly go through the space. As a result, the rotational speeds of the rotary shafts 2 and 2′ are reduced because the winds W1 and W2 blowing in different directions offset each other. In this manner, the apparatus for wind power generation with a vertical axis has an effective value of minimizing the damage to the equipment under specific climate conditions such as a strong wind or a tempest, but has a low power generation yield under everyday climate conditions.

### DISCLOSURE OF INVENTION

### Technical Problem

Accordingly, the present invention has been made in an effort to solve the problems occurring in the related art, and an object of the present invention is to provide an apparatus for wind power generation with a vertical axis, in which, even if opposing winds blow toward a plurality of vertically arranged wind rotors in opposite directions, one in which electricity is generated and the other in which electricity is not generated, electricity is generated using only the wind blowing in the direction in which electricity is generated without any interference from the wind blowing in the direction in which electricity is not generated, thereby preventing rotational force from being offset by the opposing winds (W1 and W2), which blow in a special climate environment, for instance, in different directions, particularly, in Korea.

### Technical Solution

In order to achieve the above object, according to one aspect of the present invention, there is provided an apparatus for wind power generation with a vertical axis, which comprises: at least one independent energy transmission vertical joint group having at least two independent energy transmissions coupled vertically to each other, the independent energy transmissions comprising joint rotary shafts; one-way bearings, to inner circumferences of which outer circumferences of the joint rotary shafts are fixed, and which cause the joint rotary shafts to rotate when rotated in a forward direction, but run idle without rotating the joint rotary shafts when rotated in a reverse direction; plain bearings, each of which has a through-hole formed in the center thereof; joint wind rotors, which are hollow so as to mount the joint rotary shafts, on inner circumferences of which seats are formed so as to seat the one-way bearings, to outer circumferences of which cup-like blades are coupled, and at lower portions of which contact bases are formed so as to be inserted into the through-holes of the plain bearings; cradle tubes, which are hollow, on inner circumferences of which seats are formed so as to seat the plain bearings, and upper surfaces of which are not in contact with the joint wind rotors when assembled; fixture joint members, fixing the independent energy transmission vertical joint groups in a transverse direction; a first bevel gear, coupled to the joint rotary shaft of the lowermost one of the independent energy transmissions constituting each independent energy transmission vertical joint group; a second bevel gear, engaged with the first bevel gear; a power relay shaft passing through and fixed to the second bevel gear; a gear box coupled to one end of the power relay shaft; and a power generator coupled to the gear box and generating electricity using a transmitted rotational force as power.

According to another aspect of the present invention, in order to vertically couple the independent energy transmissions, the joint rotary shafts are integrally formed, at opposite ends thereof, with joint studs, on outer circumferences of which male splines are formed; joint journals have female splines formed on inner circumferences thereof; and the joint studs of the joint rotary shafts, which are disposed in a row, are inserted into the joint journals in opposite directions.

According to another aspect of the present invention, the fixture joint members include joint fixture tubes and struts; the cradle tubes are provided with flanges at ends thereof; the flanges of the cradle tubes of two adjacent independent energy transmissions constituting each independent energy transmission vertical joint group are brought into contact with the joint fixture tube and then are fixed by a fastener; and the joint fixture tubes, which are vertically disposed, are coupled between the struts.

According to another aspect of the present invention, the apparatus further comprises additional supports disposed under the joint fixture tubes such that the flanges of the cradle tubes can be firmly fixed to the joint fixture tubes of the fixture joint members and are fixed by a fastener and then nuts, wherein the supports are provided with through-holes through which the joint rotary shafts pass.

According to another aspect of the present invention, in order to couple the first bevel gear to the joint rotary shaft of the lowermost one of the independent energy transmissions constituting each independent energy transmission vertical joint group, the apparatus further comprises: a rotational force transmission shaft, which is inserted into the female spline of the joint journal coupled to the joint rotary shaft; a one-way bearing for the transmission shaft, which is press-fitted around the joint rotary shaft, is engaged when the joint rotary shaft is rotated in a forward direction, and runs idle when the joint rotary shaft is rotated in a reverse direction; an idle induction tube, which is fitted around the one-way bearing, is coupled to the first bevel gear on one side thereof, is rotated together with the first bevel gear when the joint rotary shaft is rotated in a forward direction, and runs idle when the joint rotary shaft is stopped and when the second bevel gear is rotated in a forward direction.

### ADVANTAGEOUS EFFECTS

According to the inventive apparatus for wind power generation with a vertical axis as described above, even if the opposing winds blow toward the plurality of vertically arranged wind rotors in opposite directions, one in which electricity is generated and the other in which electricity is not generated, electricity is generated using only the wind blowing in the direction in which electricity is generated without any interference from the wind blowing in the direction in which electricity is not generated, so that the efficiency of power generation can be improved.

Further, even if the forward wind and the reverse wind blow toward the wind rotors coupled to joint rotary shafts, the rotational force transmitted from the reverse wind is dissipated by the idling of the wind rotors without being transmitted to the joint rotary shafts, so that the occurrence of fatigue failure is minimized.

### BRIEF DESCRIPTION OF THE DRAWINGS

FIG. 1 is a perspective view illustrating an existing apparatus for wind power generation with a vertical axis;

FIG. 2 is a sectional view illustrating the state of a wind rotor blade having the construction of FIG. 1 when in use;

FIG. 3 is a perspective view illustrating an apparatus for wind power generation with a vertical axis of the present invention;

FIG. 4 is a sectional view illustrating important parts of an apparatus for wind power generation with a vertical axis of the present invention;

FIG. 5 is a disassembled sectional view illustrating one of the independent energy transmissions of FIG. 4; and

FIG. 6 is an assembled sectional view illustrating fixture joint members coupling a group of independent energy transmission vertical joints.

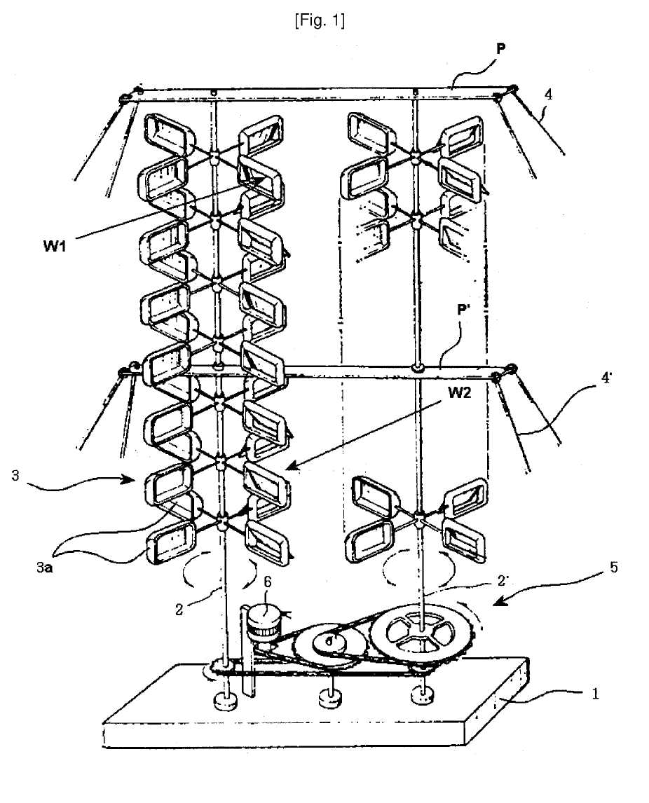

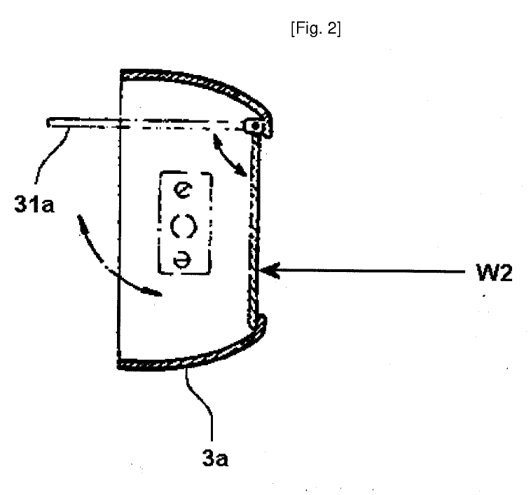

### DESCRIPTION OF SYMBOLS OF THE MAIN PARTS IN THE DRAWINGS

10a, 10b: joint rotary shaft 11a, 11b: joint stud
12a, 12b: joint journal
20a, 20b: one-way bearing for joint rotary shaft
30a, 30b: plain bearing 40a, 40b: joint wind rotor
41a, 41b, 51a, 51b: seat 42a, 42b: cup-like blade
43a, 43b: contact base 50a, 50b: cradle tube
52a, 52b: flange 61a, 61b, 360: ball bearing
70a, 70b: protective cover 80a, 80b: support ring
100a, 100b: independent energy transmission
200: fixture joint member 10: joint fixture tube
220: fastener 221: bolt
222, 223: nut 230: strut
240: support 310, 320: bevel gear
330: rotational force transmission shaft
340: one-way bearing for transmission shaft
350: idle induction tube 400: power relay shaft
500: gear box 600: power generator
A: independent energy transmission vertical joint group

### BEST MODE FOR CARRYING OUT THE INVENTION

Reference will now be made in greater detail to an exemplary embodiment of the invention, an example of which is illustrated in the accompanying drawings.

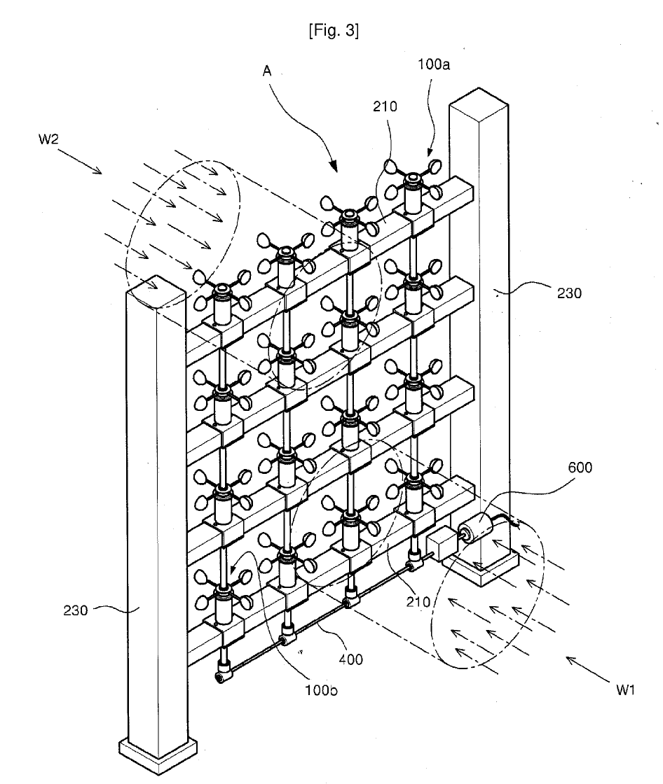

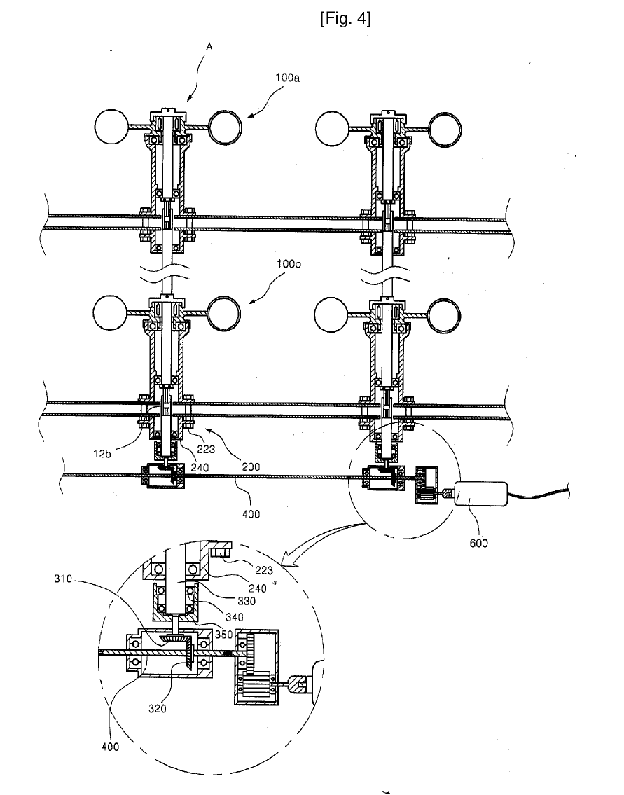

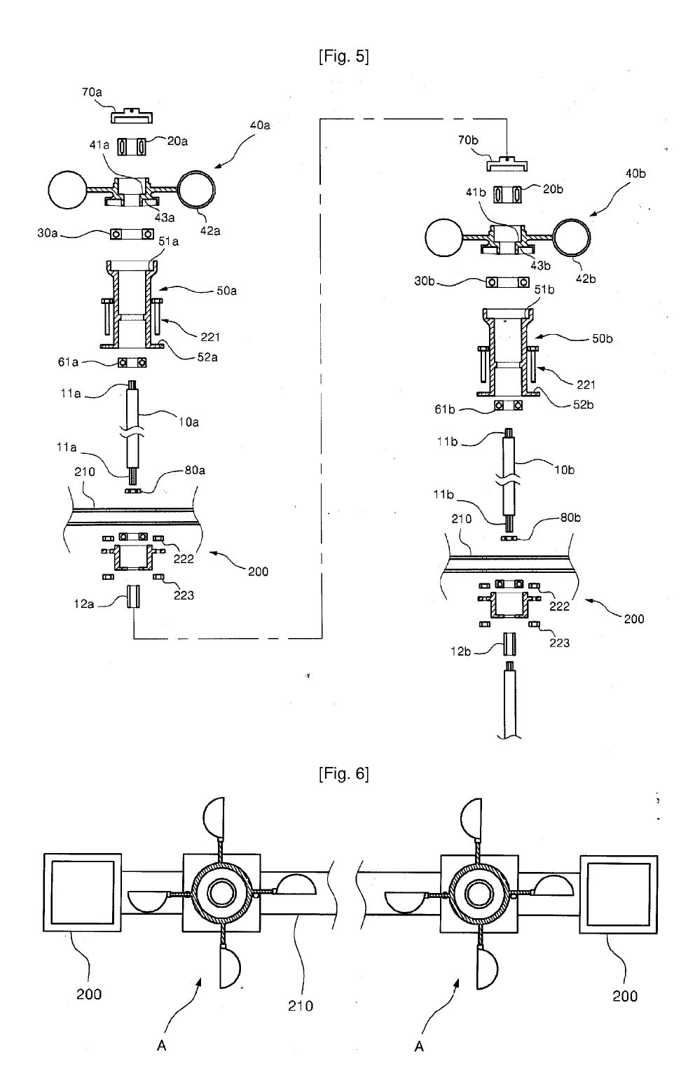

FIG. 3 is a perspective view illustrating an apparatus for wind power generation with a vertical axis of the present invention. FIG. 4 is a sectional view illustrating important parts of an apparatus for wind power generation with a vertical axis of the present invention. FIG. 5 is a disassembled sectional view illustrating one independent energy transmission of FIG. 4. FIG. 6 is an assembled sectional view illustrating a fixture for connecting a set of vertical joints in each independent energy transmission.

As illustrated, the apparatus for wind power generation with a vertical axis of the present invention comprises a plurality of independent energy transmissions, which are assembled with each other.

First, in order to assemble a first one 100a of the independent energy transmissions, a one-way bearing 20a for a first joint rotary shaft is press-fitted into the seat 41a of a joint wind rotor 40a.

Here, the joint wind rotor 40a, in which the one-way bearing 20a is fixed, is covered with a protective cover 70a over an upper portion thereof so as to prevent foreign materials such as rainwater from being introduced from the outside.

Further, the joint wind rotor 40a has four cup-like blades 42a fixed on the outer circumference thereof in a radial direction. Alternatively, the number of cup-like blades 42a can be set to three or five depending on the size of the independent energy transmission.

Then, a plain bearing 30a is placed in the seat 51a of a cradle tube 50a, and then a ball bearing 61a is press-fitted into the plain bearing 30a.

Next, a contact base 43a of the joint wind rotor 40a is fitted into the cradle tube 50a in which the plain bearing 30a is placed. Thereby, the plain bearing 30a is closely connected between the placed joint wind rotor 40a and the cradle tube 50a. Thus, the joint wind rotor 40a is not in direct contact with the cradle tube 50a, so that the joint wind rotor 40a can be independently rotated without interference from the cradle tube 50a.

Subsequently, the joint rotary shaft 10a is inserted so as to pass through the placed one-way bearing 20a and the ball bearing 61a inside the plain bearing 30a. Thereby, the assembly of the independent energy transmission is completed. Here, the joint rotary shaft 10a is also press-fitted into the one-way bearing 20a.

The protective cover 70a, which is covered over the upper portion of the joint wind rotor 40a, is preferably fixed to the joint rotary shaft 10a, passing therethrough, using a pin.

Further, the joint rotary shaft 10a passing through the ball bearing 61a is preferably fixed to a support ring 80a at a lower end thereof such that the ball bearing 61a, fitted around the outer circumference of the joint rotary shaft 10a, can firmly withstand external impacts.

In this manner, even if forward wind (counterclockwise wind), in the direction of which power generation force is provided, and reverse wind (clockwise wind), in the direction of which power generation force is not provided, blow at the same time, the assembled independent energy transmission 100a can generate electricity using only the forward wind, without interference from the reverse wind.

In other words, in the case in which the wind blows in a forward direction, the joint wind rotor 40a is rotated in a counterclockwise direction. At this time, the one-way bearing 20a is installed on the seat 41a of the rotating joint wind rotor 40a, and thus is rotated therewith in a counterclockwise direction.

In this manner, when rotated in a counterclockwise direction, the one-way bearing 20a causes the joint rotary shaft 10a to rotate in a forward direction, which is the direction in which electricity is generated, because the joint rotary shaft 10a, which is fixed to the inner circumference of the one-way bearing 20a, is rotated in engagement with the one-way bearing 20a.

In contrast, in the case in which the wind blows in a reverse direction, the joint wind rotor 40a is rotated in a clockwise direction. Thus, the one-way bearing 20a, fixed to the rotating joint wind rotor 40a, is rotated therewith in a clockwise direction. At this time, the one-way bearing 20a is not engaged with the joint rotary shaft 10a, which is fixed to the inner circumference of the one-way bearing 20a, because rotational force is transmitted in a counterclockwise direction. Hence, the one-way bearing 20a runs idle, so that it does not transmit rotational force to the joint rotary shaft 10a. As a result, the efficiency of power generation is improved.

Afterwards, components constituting a second one 100b of the independent energy transmissions, i.e. a joint rotary shaft 10b, a one-way bearing 20b for a second joint rotary shaft, a plain bearing 30b, a joint wind rotor 40b, a cradle tube 50b, a ball bearing 61b, a protective cover 70b, and a support ring 80b, are assembled with each other, as in the first independent energy transmission 100a. Here, among the reference numerals that have not yet been described, 11b indicates a joint stud, 12b indicates a joint journal, 41b and 51b indicate seats, 42b indicates a cup-like blade, and 43b indicates a contact base.

Afterwards, a joint journal 12a is interposed between the joint rotary shaft 10a of the assembled first independent energy transmission 100a and the joint rotary shaft 10b of the assembled second independent energy transmission 100b, and then the joint studs 11a and 11b of the joint rotary shafts 10a and 10b are inserted into opposite sides of the joint journal 12a. At this time, each of the joint studs 11a and 11b is provided with a male spline on the outer circumference thereof, and the joint journal 12a is provided with a female spline on the inner circumference thereof. Thus, the joint studs 11a and 11b are journaled in the joint journal 12a.

Here, in the case of the upper and lower joint studs 11a, protruding from opposite ends of each joint rotary shaft 10a, the lower joint stud 11a is longer than the upper joint stud 11a. The lower joint stud 11a is so long that the upper joint stud 11b of the joint rotary shaft 10b, disposed below the joint rotary shaft 10a, is exposed to the outside when the joint journal 12a moves upwards in the state where the joint journal 12a is inserted into the joint rotary shafts 10a and 10b. This enables easy maintenance and repair of the respective joint wind rotors 40a and 40b.

Thereafter, as many independent energy transmissions as are needed are vertically joined through the above-described process. Thereby, a plurality of vertical joint groups A of independent energy transmissions is prepared.

At this time, fixture joint members 200 are horizontally coupled between the independent energy transmission vertical joint groups A such that the independent energy transmission vertical joint groups A are firmly fixed to each other.

To this end, the cradle tube 50a or 50b of each independent energy transmission 100a or 100b is provided with a flange 52a or 52b at one end thereof, and each fixture joint member 200 is provided with a joint fixture tube 210, and is couple to struts 230. The flange 52a or 52b of the cradle tube 50a or 50b of each independent energy transmission, constituting an independent energy transmission vertical joint group A, is brought into contact with a corresponding joint fixture tube 210, and is then fixed by a fastener 220 having bolts 221 and nuts 222. In this case, the number of joint fixture tubes 210 coupled between the independent energy transmission vertical joint groups A can be adjusted to correspond to the number of cradle tubes 50a and 50b of the independent energy transmissions constituting each independent energy transmission vertical joint group A.

Then, the joint fixture tubes 210, which are coupled along the independent energy transmission vertical joint groups A, are fixedly coupled to struts 230 (for example, by fitting or screwing), so as to be more firmly supported to withstand impacts transmitted from the outside. Here, the number of struts 230 can be two, as illustrated in FIG. 3. In the case in which the number of independent energy transmission vertical joint groups A is high, the struts can be disposed between the independent energy transmission vertical joint groups A at predetermined intervals.

Further, a support 240 is additionally disposed under the joint fixture tube 210 of the fixture joint member 200 such that the flange 52a or 52b of the cradle tube 50a or 50b can be firmly fixed to the joint fixture tube 210 of the fixture joint member 200, and is fixed by a fastener 220 having bolts 221 and nuts 222. In this case, the support 240 is provided with a through-hole, through which the joint rotary shaft 10a or 10b passes.

Afterwards, the joint rotary shaft 10b of the lowermost one 100b among the independent energy transmissions 100a and 100b constituting each independent energy transmission vertical joint group A is connected with a rotational force transmission shaft 330 using the joint journal 12b.

A one-way bearing 340 for the transmission shaft is press-fitted around the joint rotary shaft 10b, and then the press-fitted one-way bearing 340 is again fitted into an idle induction tube 350. Then, the idle induction tube 350 is coupled to a first bevel gear 310 on one side thereof.

Here, the reason that the one-way bearing 340 and the idle induction tube 350 are interposed between the joint rotary shaft 10b and the first bevel gear 310 is to maximize the efficiency of power generation by, in the case in which at least one of the independent energy transmission vertical joint groups A is stopped because there is no forward wind, and in which the others are rotated in a forward direction because there is forward wind, preventing rotational force transmitted from the other independent energy transmission vertical joint groups A from being used to rotate the stopped independent energy transmission vertical joint group A.

In other words, the outer circumference of the one-way bearing 340 is fitted into the inner circumference of the idle induction tube 350, and the first bevel gear 310 is coupled to one side of the idle induction tube 350. Thereby, when the rotational force transmission shaft 330, connected with the joint rotary shaft 10b, is rotated in a forward direction by the forward rotational force transmitted from the independent energy transmission vertical joint groups A, the one-way bearing 340 fitted around the rotational force transmission shaft 330 is engaged and rotated together, and thus the first bevel gear 310 is rotated.

In contrast, when the rotational force transmission shaft 330, connected with the joint rotary shaft 10b of any independent energy transmission vertical joint group A, is stopped, the idle induction tube 350, coupled with the first bevel gear 310, is rotated in a forward direction by the rotational force transmitted from the other independent energy transmission vertical joint groups A. At this time, the one-way bearing 340 fixed to the inner circumference of the idle induction tube 350 runs approximately idle relative to the idle induction tube 350, so that no rotational force is transmitted from the idle induction tube 350 to the joint rotary shaft 10b. In this manner, because the transmitted rotational force is used to rotate the idle induction tube 350, the efficiency of power generation can be improved.

A ball bearing 360 is fitted around one end of the rotational force transmission shaft 330, so that the rotational force transmission shaft 330 can be more smoothly rotated. Thereafter, the rotational force transmission shaft 330, the one-way bearing 340 for the transmission shaft, the idle induction tube 350, and the first bevel gear 310 are installed on the other independent energy transmission vertical joint groups A.

Afterwards, a power relay shaft 400 passes through each second bevel gear 320, which is engaged with each first bevel gear 310. The power relay shaft 400 is coupled to a gear box 500 at one end thereof, and the gear box 500 is coupled to a power generator 600.

Here, the power generator 600 is electrically connected with a storage battery (not shown), so that the electricity generated from the power generator can be accumulated. Further, the gear box 500 can use various gears, for instance, spur gears. Alternatively, a plurality of power generators 600 may be installed. In this case, the number of power generators can be increased in proportion to the number of independent energy transmission vertical joint groups A. Further, each pair of bevel gears 310 and 320 and the gear box 500 are mounted in corresponding housings, to protect them from external impacts as well as the introduction of foreign materials. Furthermore, each housing is preferably provided therein with ball bearings such that the coupled gear and shaft can be smoothly rotated.

In this manner, the independent energy transmission vertical joint groups A, each of which has the independent energy transmissions 100a and 100b coupled vertically to each other, are arranged in a horizontal direction. Thereby, the joint wind rotors 40a and 40b are regularly disposed longitudinally and transversely, that is, in a matrix arrangement.

According to the apparatus for wind power generation with a vertical axis, having this structure, of the present invention, due to the special climate environment in Korea, when a forward wind W1 blows in the direction in which electricity is generated (herein, a counterclockwise direction from the front to the rear of each independent energy transmission vertical joint group A) at a right lower portion of the cuboid in which the joint wind rotors 40a and 40b are regularly disposed in a matrix arrangement and simultaneously, when a reverse wind W2 blows in a direction in which no electricity is generated (herein, a counterclockwise direction from the rear to the front of each independent energy transmission vertical joint group A) at a left upper portion of the cuboid, each joint wind rotor 40a is rotated in the counterclockwise direction at the portion where the forward wind W1 blows.

At this time, each one-way bearing 20a, fixed to the inner circumference of each joint wind rotor 40a, is rotated in the counterclockwise direction, so that each joint rotary shaft 10a, engaged when each joint wind rotor is rotated in the forward direction, is also rotated in the forward direction.

Further, the rotational force transmission shaft 330 is fixedly coupled to the lowermost one 10b of the joint rotary shafts, and is sequentially coupled with the one-way bearing 340, the idle induction tube 350, into which the one-way bearing 340 is press-fitted, and the first bevel gear 310. Thus, the one-way bearing 340 coupled to the rotational force transmission shaft 330 is rotated in engagement with the rotational force transmission shaft 330 when it is rotated in the forward direction, so that the idle induction tube 350, into which the one-way bearing 340 is press-fitted, and the first bevel gear 310 are also rotated in the forward direction.

The first bevel gear 310 is engaged with the second bevel gear 320, through which the power relay shaft 400 is fixed, and one end of the power relay shaft 400 is coupled to the gear box 500. Thereby, the transmitted rotational force causes the power relay shaft 400 to be rotated together with the gear box 500, so that the power generator 600 coupled with the gear box 500 can generate the electricity. The generated electricity can be accumulated in the storage battery through conductive wires.

The other joint wind rotors 40b are rotated in a clockwise direction by the reverse wind W2. At this time, the one-way bearing 20b, fixed to the inner circumference of each of the other joint wind rotors 40b, is also rotated in a clockwise direction. In this case, when rotated in a reverse direction, each one-way bearing 20b runs idle without engaging any of the other joint rotary shafts 10b. Thus, none of the other joint wind rotors 40b transmit any rotational force to any of the other joint rotary shafts 10b, thereby providing no interference to any of the joint rotary shafts 10a, which rotate in the forward direction.

Meanwhile, as described above, in the case of the existing vertical axial wind generator, when the winds W1 and W2 blow at the same time, it is impossible for the wind rotors thereof to rotate from a mathematical standpoint. However, in the case of the inventive vertical axial wind generator, if the maximum efficiency of rotation is 100%, the wind rotors can rotate at least 50% efficiency from a mathematical standpoint. In this manner, it can be found that the efficiency of power generation of the inventive vertical axial wind generator is improved over that of the existing vertical axial wind generator.

Moreover, in the case of the existing apparatus for wind power generation having a vertical axis, when the forward wind W1 and the reverse wind W2 blow at the same time, each wind rotor is not rotated due to the intensity (or the external force) of the concurrent winds, and is twisted by the external force.

In the case in which this situation persists, the joint that connects the rotary shaft, which is unstable from the standpoint of the energy level, with the wind rotors has a high probability of fatigue failure. In contrast, in the case of the inventive apparatus for wind power generation with a vertical axis, the rotational force transmitted by the reverse wind is not transmitted to the joint rotary shaft 10b, and is dissipated by the idling of the wind rotor 40b, so that the occurrence of fatigue failure is minimized, unlike the existing apparatus for wind power generation with a vertical axis.

Even when any one of the independent energy transmission vertical joint groups A is stopped, only the idle induction tube 350 having the one-way bearing 340 relaying the rotational force between the independent energy transmission vertical joint groups A and the power generator 600 runs idle, so that the rotational force transmitted from the other independent energy transmission vertical joint groups A is prevented from rotating the stopped independent energy transmission vertical joint group A, and thus the efficiency of power generation is kept optimal.

1. An apparatus for wind power generation with a vertical axis, comprising:
at least one independent energy transmission vertical joint group, having at least two independent energy transmissions coupled vertically to each other, wherein the independent energy transmissions comprise joint rotary shafts;
one-way bearings, engaged to inner circumferences, said inner circumferences being fixed to outer circumferences of the joint rotary shafts, the joint rotary shafts being rotated when rotated in a forward direction and being idle when rotated in a reverse direction;
plain bearings, each plain bearing having a through-hole formed through a center thereof;
joint wind rotors being hollow so as to permit mounting of the joint rotary shafts and having inner circumferences forming seats to engage the one-way bearings and having outer circumferences coupled to cup-like blades, said joint wind rotors having lower portions contacting bases inserted into through-holes of the plain bearings;
cradle tubes, being hollow and forming seats on inner circumferences thereof, the plain bearings and upper surfaces separated from the joint wind rotors when assembled;
fixture joint members, fixing the independent energy transmission vertical joint groups in a transverse direction;
a first bevel gear, being coupled to the joint rotary shaft of a lowermost one of the independent energy transmissions constituting each independent energy transmission vertical joint group;
a second bevel gear engaged with the first bevel gear;
a power relay shaft passing through and fixed to the second bevel gear;
a gear box coupled to one end of the power relay shaft; and
a power generator coupled to the gear box and generating electricity using transmitted rotational force as power.

2. The apparatus as set forth in claim 1, wherein, in order to vertically couple the independent energy transmissions, the joint rotary shafts are integrally formed, at opposite ends thereof, with joint studs, on outer circumferences of which male splines are formed, said joint studs having joint journals formed with female splines on inner circumferences thereof, said joint studs being disposed in a row and inserted into the joint journals in opposite directions.

3. The apparatus as set forth in claim 1, wherein the fixture joint members each comprise joint fixture tubes and struts, said cradle tubes being provided with flanges at ends thereof, said flanges of the cradle tubes of two adjacent independent energy transmissions constituting each independent energy transmission vertical joint group contacting the joint fixture tube and being fixed by a fastener, the joint fixture tubes being vertically disposed and coupled between the struts.

4. The apparatus as set forth in claim 3, further comprising:
additional supports disposed under the joint fixture tubes, the flanges of the cradle tubes being firmly fixed to the joint fixture tubes of the fixture joint members and fixed by a fastener and nuts, wherein the supports are comprised of through-holes through which the joint rotary shafts pass.

5. The apparatus as set forth in claim 1, further comprising:
in order to relay the first bevel gear, coupled to the joint rotary shaft of the lowermost one of the independent energy transmissions constituting each independent energy transmission vertical joint group, a rotational force transmission shaft, being inserted into the female spline of the joint journal coupled to the joint rotary shaft;
a one-way bearing, for the transmission shaft, being press-fitted around the joint rotary shaft and being engaged when the joint rotary shaft is rotated in a forward direction and running idle when the joint rotary shaft is rotated in a reverse direction;
an idle induction tube being fitted around the one-way bearing, coupled to the first bevel gear on one side thereof, and rotated together with the first bevel gear when the joint rotary shaft is rotated in a forward direction, and running idle when the joint rotary shaft is stopped and when the second bevel gear is rotated in a forward direction.
